(19) United States
(12) Patent Application Publication
(10) Pub. No.: US 2021/0354916 A1
(43) Pub. Date: Nov. 18, 2021

(54) COMPONENT FEEDING SYSTEM

(71) Applicant: SAMUEL, SON & CO. (USA) INC., Woodridge, IL (US)

(72) Inventor: Joseph Dude Reynolds, Tucson, AZ (US)

(73) Assignee: SAMUEL, SON & CO. (USA) INC., Woodridge, IL (US)

(21) Appl. No.: 17/287,076

(22) PCT Filed: Oct. 31, 2019
(86) PCT No.: PCT/US2019/058745

§ 371 Date: Apr. 20, 2021

Related U.S. Application Data
(60) Provisional application No. 62/757,342, filed on Nov. 8, 2018.

(51) Int. Cl. B65G 1/04; B65G 25/08; B65G 47/91

(52) U.S. Cl. CPC B65G 1/0442; B65G 2201/0217; B65G 47/91; B65G 25/08

(57) ABSTRACT

A system for singulating a component comprises a hopper, a singulating blade, and an actuator. The hopper further comprises a back wall, a hopper wall, a singulating wall, and a feed surface, the back wall rigidly connected to both the hopper wall and the singulating wall. The singulating blade is configured to slide between the hopper wall and the singulating wall between a first position and a second position. An actuator is configured to move the singulating blade between the first position and the second position so as to selectively carry a component to a component pocket defined by the singulating wall.

### CROSS REFERENCE TO RELATED APPLICATIONS

The present application claims priority to U.S. Provisional Patent Application No. 62/757,342 filed Nov. 8, 2018, the content of which is incorporated herein by reference in its entirety.

### TECHNICAL FIELD

The present invention relates to component feeding systems. More particularly, the present invention relates to systems for feeding cylindrical components to other equipment for further processing.

### BACKGROUND

Component feeding systems are often used to feed raw materials to additional manufacturing equipment for further processing. In one conventional component feeding system for feeding cylindrical components, a batch of components is held in a hopper. The component feeder then separates a single cylindrical component from the batch and provides the single component for subsequent manufacturing processes. In such conventional component feeding systems for feeding cylindrical components, the component feeder can become stuck or can accidentally provide more than one component. In addition, some cylindrical components include knurled or stamped ends such that when the components are in a batch the components do not lay flat, which can increase the likelihood of delays. In these cases, the additional manufacturing processes cannot continue until the component feeding system is running properly, which increases both cost and throughput time. An improved component feeding system is required to improve the efficiency of the feeding system and reduce downtime.

### SUMMARY

Various embodiments provide a system to singulate a component from a batch of components for further manufacturing processes. The system includes a hopper comprising a back wall, a hopper wall, and a singulating wall, the hopper wall and singulating wall coupled to the back wall. A singulating blade is configured to slide between the hopper wall and the singulating wall between a first position and a second position. The hopper is sized and configured to receive a batch of components, and a feed surface of the hopper allows the components to move toward the singulating blade. The singulating blade is actuated to move toward a component pocket defined by the singulating wall. As the singulating blade moves toward the component pocket, the singulating blade contacts a component from the batch of components and moves the component toward the component pocket. The component is then deposited in the component pocket, and the actuator moves the singulating blade back to its original position. The component within the component pocket can then be moved for subsequent manufacturing processes.

Additional embodiments provide a system for singulating a component. The system includes a hopper configured to contain at least one component. The hopper includes a back wall, a hopper wall, a singulating wall, and a feed surface. The back wall is connected to both the hopper wall and the singulating wall. A singulating blade is configured to slide between the singulating wall and the hopper wall between a first position and a second position, the singulating wall defining a component pocket sized and configured to receive the component. An actuator is in communication with the singulating blade, the actuator configured to move the singulating blade between the first position and the second position so as to selectively carry the component to the component pocket. The singulating blade defines a top portion configured to contact the component as the singulating blade moves between the first position and the second position.

Further embodiments provide a system for singulating a component. The system includes a hopper configured to contain at least one component. The hopper includes a back wall, a hopper wall, and a singulating wall, where the back wall is connected to both the hopper wall and the singulating wall. A feed surface is configured to direct the component toward the singulating wall. A singulating blade is configured to slide between the singulating wall and the hopper wall between a first position and a second position, the singulating wall defining a component pocket sized and configured to receive the component. An actuator is in communication with the singulating blade, the actuator configured to move the singulating blade between the first position and the second position so as to selectively carry the component to the component pocket.

These and other features, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is a perspective view of a component feeding system in a first configuration, according to a particular embodiment.

FIG. 2 is a perspective view of the component feeding system of FIG. 1 in a second configuration.

FIG. 3 is a perspective view of the component feeding system of FIG. 1 in a third configuration.

FIG. 4 is a perspective view of the component feeding system of FIG. 1 in a fourth configuration.

FIGS. 5A-D are perspective views of variations of a feed surface of the component feeding system of FIG. 1, according to particular embodiments.

FIGS. 6A-B are perspective views of variations of a singulating wall of the component feeding system of FIG. 1, according to particular embodiments.

FIGS. 7A-B are perspective views of variations of a singulating wall of the component feeding system of FIG. 1, according to particular embodiments.

FIGS. 8A-C are perspective views of variations of a singulating blade of the component feeding system of FIG. 1, according to particular embodiments.

FIG. 9 is a perspective view of a variation of a singulating blade of the component feeding system of FIG. 1, according to a particular embodiment.

FIGS. 10A-C are perspective views of variations of a component pocket of the component feeding system of FIG. 1, according to particular embodiments.

### DETAILED DESCRIPTION

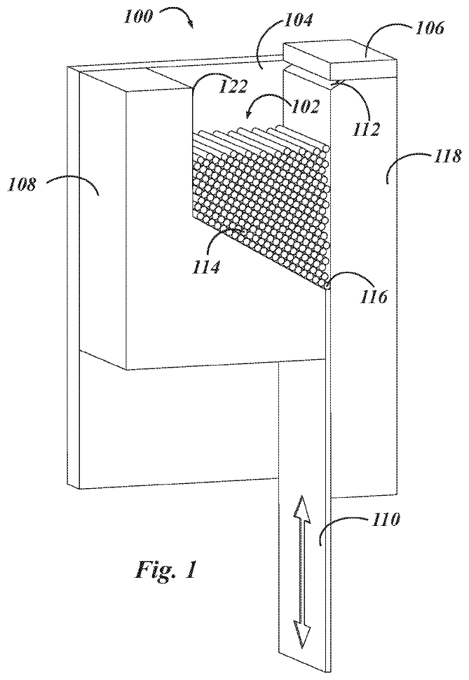

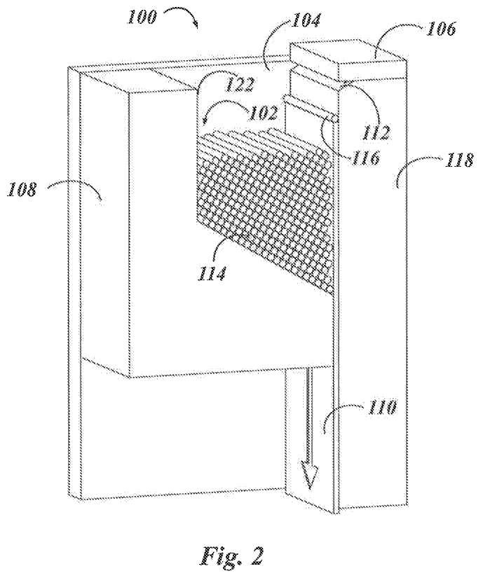

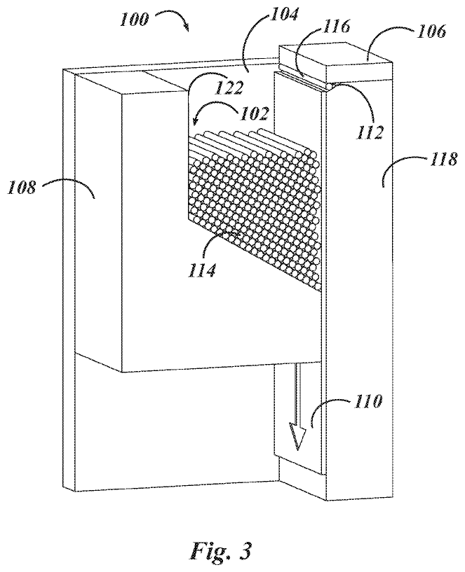

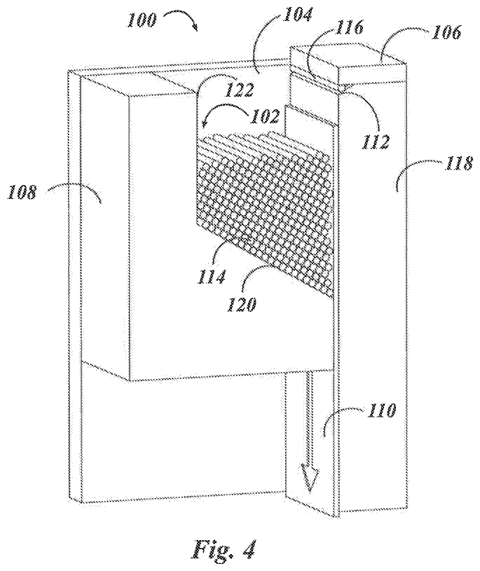

FIGS. 1-4 show perspective views of a component feeder system 100 according to a particular embodiment. The component feeder system 100 may be used when singulating components. As used herein, the term “singulating” refers to isolating and separating a single component from a batch of similar components. The component feeder system 100 includes a hopper 102 having a back wall 104, a hopper wall 108, and a singulating wall 118. The component feeder system 100 also includes a singulating blade 110 and a top plate 106. The back wall 104, the hopper wall 108, the singulating wall 118, and the top plate 106 may be constructed of, for example, metallic materials such as stainless steel, aluminum, or other metals suitable for manufacturing. The back wall 104, the hopper wall 108, the singulating wall 118, and the top plate 106 may also be constructed of, for example, plastic materials such as polycarbonate, ABS, or other plastics suitable for manufacturing. The choice of material may depend on the particular manufacturing environment. The hopper wall 108 is rigidly connected to the back wall 104, and the singulating wall 118 is also rigidly connected to the back wall 104. The hopper wall 108 and the singulating wall 118 are arranged such that there is a space therebetween, allowing a singulating blade 110 to slide in between the hopper wall 108 and the singulating wall 118.

The singulating blade 110 may be constructed of, for example metallic materials such as stainless steel, aluminum, or other metals suitable for manufacturing. The singulating blade 110 may also be constructed of, for example, plastic materials such as polycarbonate, ABS, or other plastics suitable for manufacturing. The choice of material may depend on the particular manufacturing environment. The singulating blade 110 is coupled with an actuating mechanism operable to move the singulating blade 110 from a first position to a second position, and back to the first position. The actuating mechanism may be pneumatic, hydraulic, or any other type of actuator that would be suitable for manufacturing. The choice of actuator may depend on the particular manufacturing environment.

The hopper wall 108 further includes a feed surface 120. The hopper wall 108 may also include a vertical surface 122. The combination of the back wall 104, the hopper wall 108, the singulating wall 118, and the feed surface 120 defines a space in which the component batch 114 is held during the component feeding process. The component batch 114 comprises individual components 116. In some embodiments, each component 116 may be a raw cylindrical rod without any indentations, knurling, etc. In other embodiments, each component 116 may be a cylindrical rod with sections that have been knurled, stamped, or otherwise modified before entering the hopper 102. In some embodiments, the feed surface 120 may be angled such that the components 116 travel down the feed surface 120 toward the singulating blade 110.

The top plate 106 is rigidly connected to the singulating wall 118 such that a component pocket 112 is defined. The component pocket 112 is sized and configured to receive a component 116 and retain the component 116 until the component 116 is removed from the component pocket 112 for further processing by other manufacturing equipment.

In one embodiment, a component feeding operation is started and the component batch 114 is loaded into the hopper 102. The hopper 102 may be sized and configured such that the component batch 114 does not protrude beyond the boundaries of the hopper wall 108 and the singulating wall 118. In some arrangements, the hopper 102 may be sized and configured such that the component batch 114 protrudes beyond the boundaries of the hopper wall 108 and the singulating wall 118. As the components 116 of the component batch 114 settle into the hopper 102, the components 116 travel down the feed surface 120 toward the singulating blade 110. In some embodiments, the singulating blade 110 may be sized and configured such that the width (e.g., thickness) of the singulating blade 110 is equal to the diameter of the components 116. The singulating blade 110 may also be sized and configured such that the width of the singulating blade 110 is larger than or smaller than the diameter of the components 116.

The actuator in communication with the singulating blade 110 is activated, and the singulating blade 110 begins to travel toward the component pocket 112. As the singulating blade 110 travels toward the component pocket 112, the top of the singulating blade 110 contacts a component 116 and propels the component 116 toward the component pocket 112 as well. As the component 116 moves toward the component pocket 112, the component 116 contacts other components 116 in the component batch 114. Because the components 116 are cylindrical, the components 116 not in contact with the top of the singulating blade 110 roll off of the component 116 that is in contact with the top of the singulating blade 110 such that when the singulating blade 110 reaches the component pocket 112 only the component 116 that is in contact with the top of the singulating blade 110 reaches the component pocket 112. Additionally, as the singulating blade 110 moves through the component batch 114, the movement causes the components 116 within the component batch 114 to move away from the singulating blade 110, creating a loosening effect, which allows the singulating blade 110 to travel with a low amount of friction between the singulating blade 110 and the component batch 114.

The component 116 then enters the component pocket 112. In some embodiments, the component 116 rolls off of the singulating blade 110 into the component pocket 112. In some embodiments, the component 116 is pulled into the component pocket 112 using a vacuum source. The component 116 remains in the component pocket 112 until additional manufacturing equipment removes the component 116 from the component pocket 112 for additional manufacturing operations.

The actuator then moves the singulating blade 110 away from the component pocket 112 until the singulating blade 110 returns to its original position. As the singulating blade 110 moves toward its original position, the movement causes the components 116 of the component batch 114 to move toward the singulating blade 110. When the singulating blade 110 comes to rest in its original position, another component 116 contacts the top of the singulating blade 110, and the singulating process can be repeated.

In some instances, the singulating blade 110 may be actuated but fail to move a component 116 to the component pocket 112. This may be due to the component 116 not being in full contact with the singulating blade 110 when the singulating blade 110 began to move, or the component 116 being shaped such that it rolled off of the singulating blade 110 before reaching the component pocket 112. In these types of instances, even though the component 116 does not reach the component pocket 112, the singulating process does not need to stop. In a number of conventional singulating processes, when a component is not loaded or selected properly, the mechanism may get stuck or fail, and the process must be stopped so an operator can clear the failure and resume the process. In contrast, the singulating process embodied by the component feeder system 100 discussed herein will not jam, stick, or fail if a component 116 fails to reach the component pocket 112; the singulating blade 110 will simply return to its original position and begin the process again. Testing results have shown that the component feeder system 100 successfully completed 7500 cycles without a fault. However, even in the case of a fault, the component feeder system 100 has a cycle time of approximately ⅓ the cycle time of a conventional feeder system such that the component feeder system 100 is still faster than a conventional feeder system in feeding a subsequent component 116.

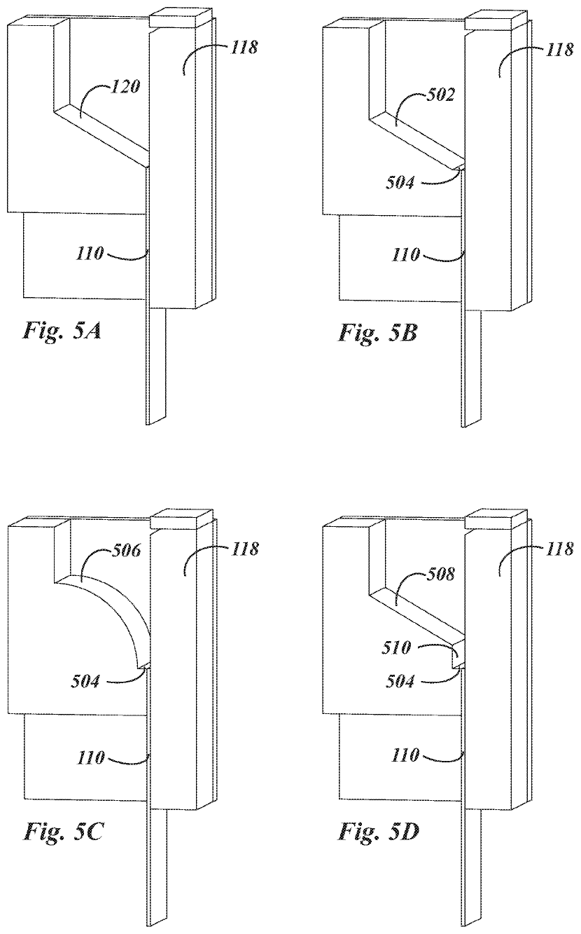

FIGS. 5A-D are perspective views of variations of a feed surface of the component feeding system 100 of FIG. 1, according to particular embodiments. In some embodiments, the feed surface 120 defines a constant angle between the feed surface 120 and the singulating wall 118, and the feed surface 120 terminates at the singulating blade 110. The angle may be modified to a shallower or steeper angle depending on the application, the types of components being fed, and the preferences of the operators. The feed surface 120 is suitable for most manufacturing applications.

In some embodiments, the feed surface 502 defines a constant angle between the feed surface 502 and the singulating wall 118, and the feed surface 502 terminates at a flat bottom 504. The flat bottom 504 extends from the feed surface 502 and terminates at the singulating blade 110. Using a system that incorporates the flat bottom 504 may be beneficial when working with components that have a higher coefficient of friction. As described with reference to FIGS. 1-4, as the singulating blade 110 moves from the component pocket 112 toward its original position, the components 116 move toward the singulating blade 110. The flat bottom 504 serves to reduce the rotation of components 116 toward the singulating blade 110 and prevent potential jams.

In some embodiments, the feed surface 506 is a convex surface that terminates at a flat bottom 504 (shown, for example, in FIGS. 5B and 5D). The flat bottom 504 extends from the feed surface 506 and terminates at the singulating blade 110. Using a system that incorporates the feed surface 506 and the flat bottom 504 may be useful when working with components that are flexible or components that are compliant with a low coefficient of friction such as rubber or plastic. The convex shape of the feed surface 506 serves to cause a higher inward force on the components toward the singulating blade 110. The inward force can straighten a flexible component and align it with the singulating blade 110 to prevent potential jams.

In some embodiments, the feed surface 508 defines a constant angle between the feed surface 508 and a vertical surface 510. A flat bottom 504 extends from the vertical surface 510 and terminates at the singulating blade 110. Using a system that incorporates the feed surface 508, the vertical surface 510, and the flat bottom 504 may be useful when working with components that may be ridged and have high friction between the components. The vertical surface 510 and the singulating wall 118 are parallel to each other and serve to reduce the pressure between the components. In some instances, the components have a coefficient of friction large enough such that the components can get stuck on each other and create a bridge between the vertical surface 510 and the singulating wall 118. The bridge of components can support the weight of the rest of the components resting on top of the bridge, and the components below the bridge within the space defined by the vertical surface 510, the flat bottom 504, and the singulating wall 118 can move more freely toward the singulating blade 110.

Additional features may be implemented separately from, or in conjunction with, the features described in FIGS. 5A-D. In some arrangements, for example, various dividers (not shown) may be located in the hopper 102 to create smaller volumes within the hopper 102. The dividers may comprise substantially vertical walls of various heights arranged along the feed surface 120. The dividers may also be substantially horizontal walls extending from the vertical surface 122 or the back wall 104. The dividers may also comprise multiple walls arranged at various angles within the hopper. The smaller volumes created by the dividers restrict component movement and/or reduce pressure on the components at the singulating wall 118 when there are a large number of components in the hopper 102.

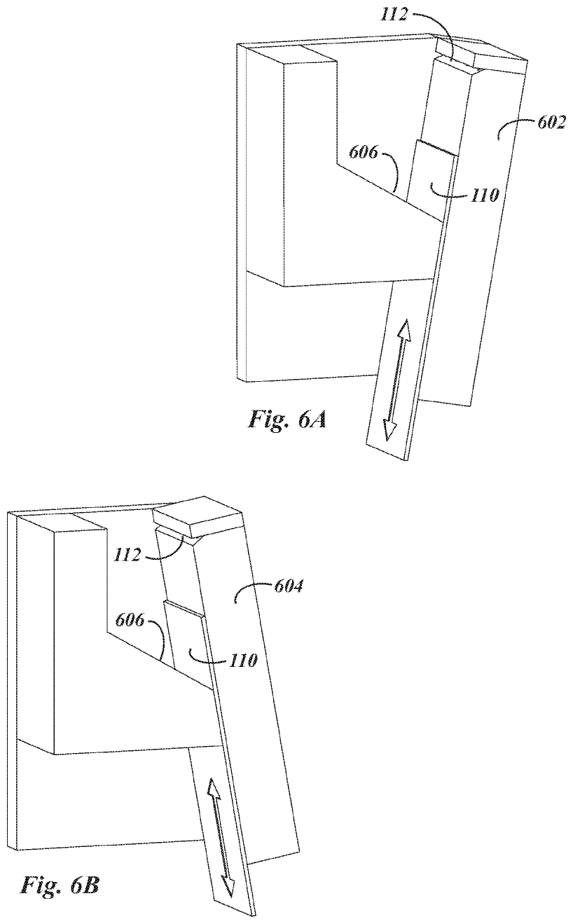

FIGS. 6A-B are perspective views of variations of a singulating wall of the component feeding system 100 of FIG. 1, according to particular embodiments. In some embodiments, the singulating wall 602 defines an angle between the singulating wall 602 and the feed surface 606 such that the angle between the two is greater than, or equal to, ninety degrees. Using a system that incorporates the singulating wall 602 and the feed surface 606 can serve to ensure the components maintain contact with the singulating wall 602 as the singulating blade 110 moves toward the component pocket 112, reducing the risk of a component 116 falling off of the singulating blade 110.

In some embodiments, the singulating wall 604 defines an angle between the singulating wall 604 and the feed surface 606 such that the angle between the two is less than, or equal to, ninety degrees. Using a system that incorporates the singulating wall 604 and the feed surface 606 can serve to reduce the number of components that are picked up by the singulating blade 110.

As shown in FIGS. 6A-B, the singulating wall 602 and the singulating wall 604 are angled relative to a vertical axis. In some embodiments, the singulating wall 602 is angled relative to a vertical axis while maintaining an angled relationship between the singulating wall 602 and the feed surface 606 that is substantially similar to the angled relationship between the singulating wall 118 and the feed surface 120 of FIG. 5A. In some embodiments, the singulating wall 604 is angled relative to a vertical axis while maintaining an angled relationship between the singulating wall 604 and the feed surface 606 that is substantially similar to the angled relationship between the singulating wall 118 and the feed surface 120 of FIG. 5A.

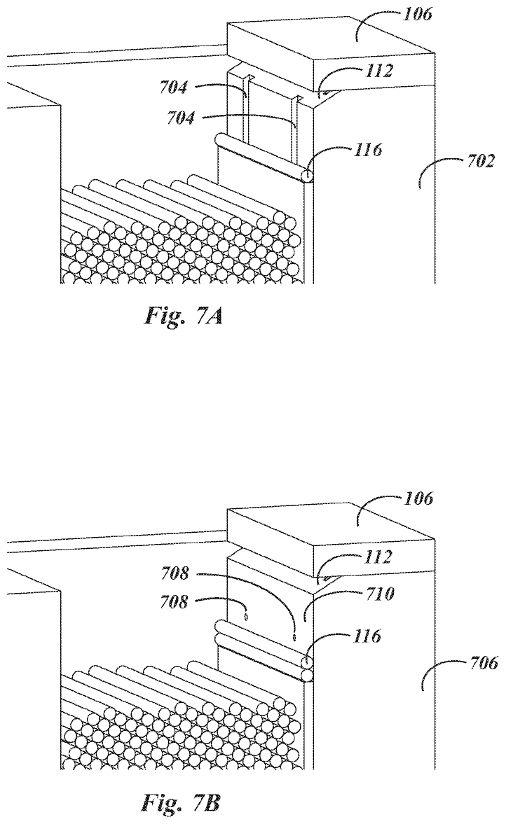

FIGS. 7A-B are perspective views of variations of a singulating wall of the component feeding system 100 of FIG. 1, according to particular embodiments. In some embodiments, the singulating wall 702 defines channels 704 that extend the length of the singulating wall 702 from the component pocket 112 to the opposite end of singulating wall 702. In some arrangements, the channels 704 originate from a single path located near the opposite end of the singulating wall 702 and split apart to create the channels 704. The channels 704 may be fluidly connected to a vacuum source such that the vacuum source pulls the component 116 toward the singulating wall 702 as the component 116 is moving toward the component pocket 112, thereby reducing the risk of a component 116 falling off of the singulating blade 110.

In some embodiments, the singulating wall 706 defines ports 708 that extend parallel to the top plate 106 through the singulating wall 706 from a vertical face of the singulating wall 710 through the opposite face of the singulating wall 706. In some arrangements, the ports 708 do not extend through the opposite face of the singulating wall 706. The ports 708 may be fluidly connected to a source of compressed gas such that the compressed gas can blow excess components 116 off of the singulating blade 110 as the singulating blade 110 moves toward the component pocket 112. In this way, the ports 708 help ensure that only one component 116 reaches the component pocket 112.

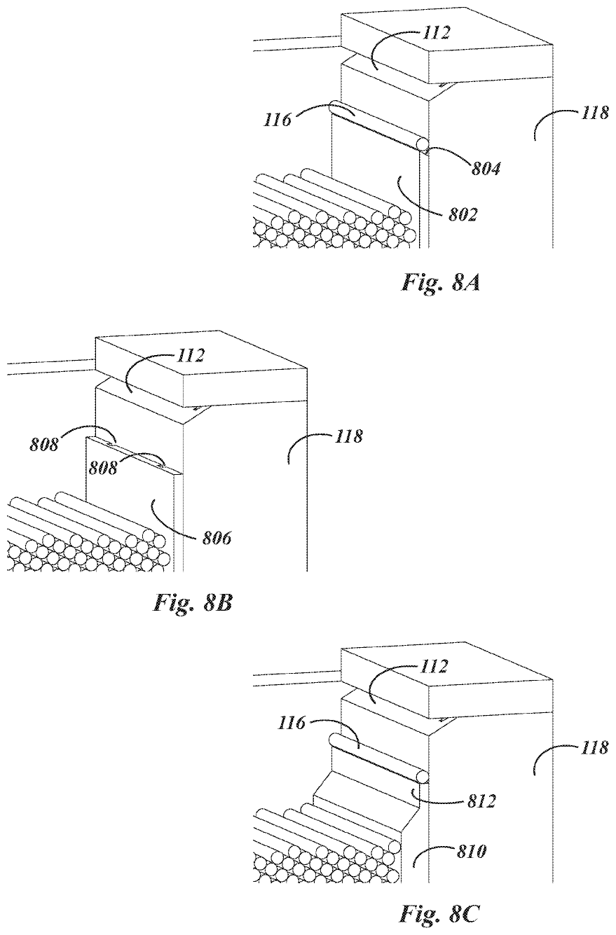

FIGS. 8A-C are perspective views of variations of a singulating blade of the component feeding system 100 of FIG. 1, according to particular embodiments. In some embodiments, the singulating blade 802 includes a beveled edge 804, the beveled edge 804 facing the singulating wall 118. The beveled edge 804 may serve to securely contact the component 116 to prevent the component 116 from rolling off of the singulating blade 802.

In some embodiments, the singulating blade 806 defines channels 808 that extend the length of the singulating blade 806 from the top of the singulating blade 806 that contacts the components 116 to the opposite end of the singulating blade 806. The channels 808 may be fluidly connected to a vacuum source such that the vacuum source pulls the component 116 toward the singulating blade 806 as the component 116 is moving toward the component pocket 112, thereby preventing the component 116 from rolling off of the singulating blade 806.

In some embodiments, the singulating blade 810 includes a section of reduced thickness 812, the section of reduced thickness 812 located at the top of the singulating blade 810 that contacts the components 116. Using a singulating blade 810 that incorporates a section of reduced thickness 812 may be useful when working with components 116 of a diameter such that, for example, the singulating blade 110 with a thickness equal to the diameter of the component 116 would be infeasible. A singulating blade 810 that incorporates a section of reduced thickness 812 may also be useful when working with materials of the singulating blade 810 that, in a thickness suitable for the application, do not exhibit sufficient physical properties required for proper singulating blade functionality.

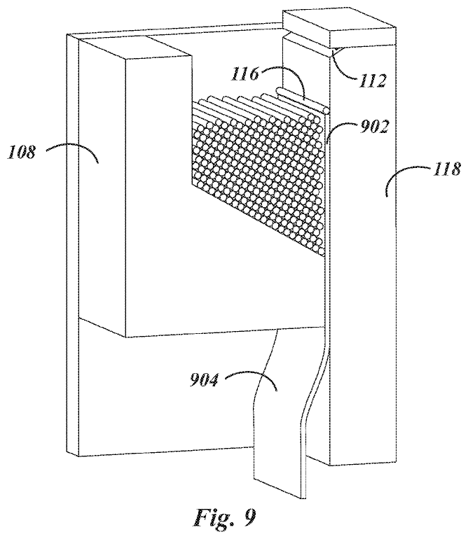

FIG. 9 is a perspective view of a variation of a singulating blade of the component feeding system 100 of FIG. 1, according to a particular embodiment. In some embodiments, the singulating blade 902 includes a flexed section 904 that is flexed such that the singulating blade 902 is not in contact with the singulating wall 118 below the flexed section 904. The singulating blade 902 may be thin and flexible such that there may be a risk of the singulating blade 902 losing contact with the singulating wall 118 as the singulating blade 902 moves a component 116 toward the component pocket 112. To avoid this risk, the singulating blade 902 can be flexed at the flexed section 904 to bias the singulating blade 902 toward the singulating wall 118 such that the singulating blade 902 remains in contact with the singulating wall 118.

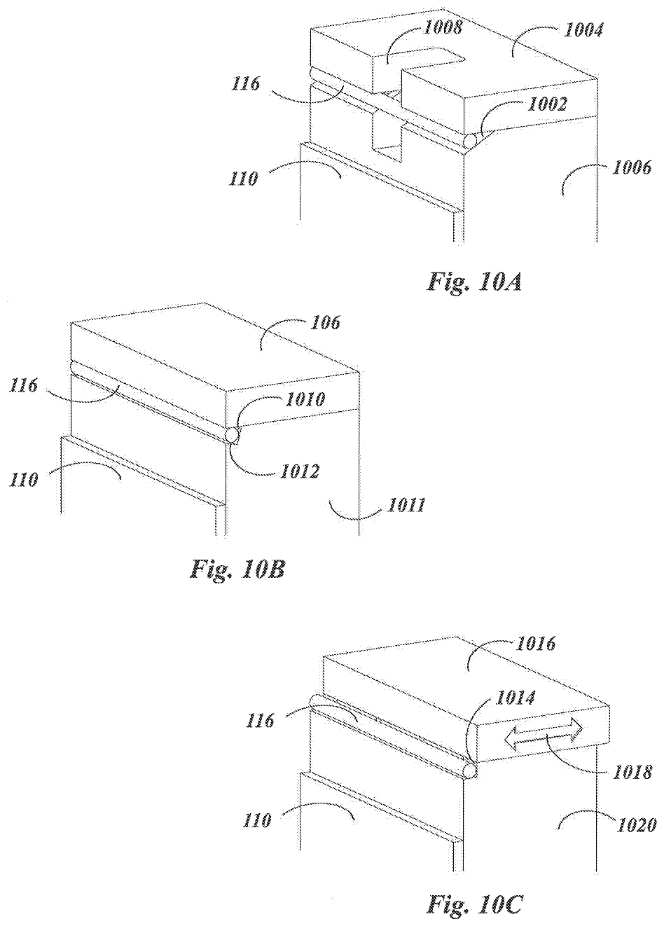

FIGS. 10A-C are perspective views of variations of a component pocket of the component feeding system 100 of FIG. 1, according to particular embodiments. In some embodiments, the component pocket 1002 is defined by the singulating wall 1006 and a top plate 1004. The component pocket 1002 is shaped like a wedge, and, in an alternative embodiment, the component 116 may be held within the component pocket 1002 via a friction fit by using the singulating blade 110 to force the component 116 far enough into the component pocket 1002 such that the component 116 is held in place by the singulating wall 1006 and the top plate 1004. The singulating wall 1006 and the top plate 1004 may further define a cavity 1008 that extends entirely through the top plate 1004 and at least partially through the singulating wall 1006. The cavity 1008 provides a space in which an operator or another machine can remove the component 116 from the component pocket 1002 and take the component 116 for further processing.

In some embodiments, the component pocket 1010 is defined by the singulating wall 1011 and the top plate 106. The component pocket 1010 includes a beveled edge 1012. The beveled edge 1012 is angled away from the singulating blade 110, serving to prevent the component 116 from rolling out of the component pocket 1010. Shaping the component pocket 1010 in this manner reduces the need to include additional mechanisms to hold the component 116 in place to prevent the component 116 from rolling out of the component pocket 1010.

In some embodiments, the component pocket 1014 is defined by the singulating wall 1020 and a top plate 1016. The top plate 1016 can travel along the singulating wall in the directions indicated by the arrow 1018. In one embodiment, the top plate 1016 is positioned such that the component 116 fits in between the top plate 1016 and the component pocket 1014. To remove the component 116 for further manufacturing operations, the top plate 1016 can move and expose the component such that the component 116 can be manipulated and moved for subsequent manufacturing processes. The movement of the top plate 1016 can occur via hydraulic, pneumatic, manual, or other methods by which components may be moved during a manufacturing process.

As utilized herein, the terms “approximately” and similar terms are intended to have a broad meaning in harmony with the common and accepted usage by those of ordinary skill in the art to which the subject matter of this disclosure pertains. It should be understood by those of ordinary skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

References herein to the positions of elements (e.g., “top,” “bottom,” “upper,” “above,” “below,” etc.) are merely used to describe the orientation of various elements in the Figures. It should be noted that the orientation of various elements may differ according to other exemplary embodiments, and that such variations are intended to be encompassed by the present disclosure.

Although only a few embodiments have been described in detail in this disclosure, those skilled in the art who review this disclosure will readily appreciate that many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter described herein. For example, elements shown as integrally formed may be constructed of multiple components or elements, the position of elements may be reversed or otherwise varied, and the nature or number of discrete elements or positions may be altered or varied. The order or sequence of any method processes may be varied or re-sequenced according to alternative embodiments. Other substitutions, modifications, changes, and omissions may also be made in the design, operating conditions and arrangement of the various exemplary embodiments without departing from the scope of the present invention.

What is claimed is:

1. A system for singulating a component, comprising:
a hopper configured to contain at least one component, the hopper comprising:
a back wall;
a hopper wall;
a singulating wall, the back wall connected to both the hopper wall and the singulating wall; and
a feed surface;
a singulating blade configured to slide between the singulating wall and the hopper wall between a first position and a second position, the singulating wall defining a component pocket sized and configured to receive the component; and
an actuator in communication with the singulating blade, the actuator configured to move the singulating blade between the first position and the second position so as to selectively carry the component to the component pocket.

2. The system of claim 1, further comprising a top plate connected to the singulating wall, the top plate further defining the component pocket.

3. The system of claim 2, wherein the singulating blade is sized and configured to transport a component from the hopper to the component pocket when the actuator moves the singulating blade from the first position to the second position.

4. The system of claim 3, further comprising a vacuum source in fluid communication with the top plate, the vacuum source configured to apply suction to the component so as to secure the component within the component pocket.

5. The system of claim 4, wherein the feed surface defines an angle, the angle being configured to allow a component to travel along the feed surface toward the singulating blade.

6. The system of claim 1, further comprising a port defined by the singulating wall, the port in fluid communication with a compressed fluid source, the port configured to direct compressed fluid from the compressed fluid source toward an additional component.

7. The system of claim 1, further comprising a channel defined by the singulating wall, the channel in fluid communication with a vacuum source, the channel is configured to direct a vacuum from the vacuum source to the component.

8. A system for singulating a component, comprising:
a hopper configured to contain at least one component, the hopper comprising:
a back wall;
a hopper wall;
a singulating wall, the back wall connected to both the hopper wall and the singulating wall; and
a feed surface;
a singulating blade configured to slide between the singulating wall and the hopper wall between a first position and a second position, the singulating wall defining a component pocket sized and configured to receive the component; and
an actuator in communication with the singulating blade, the actuator configured to move the singulating blade between the first position and the second position so as to selectively carry the component to the component pocket;
wherein the singulating blade defines a top portion configured to contact the component as the singulating blade moves between the first position and the second position.

9. The system of claim 8, wherein the top portion comprises a beveled edge.

10. The system of claim 9, wherein the beveled edge faces the singulating wall.

11. The system of claim 8, wherein the singulating blade defines a channel extending the length of singulating blade, the channel facing the singulating wall and in fluid communication with a vacuum source.

12. The system of claim 11, wherein the channel directs a vacuum from the vacuum source to the top portion so as to maintain contact between the component and the top portion as the singulating blade moves.

13. The system of claim 8, wherein the singulating blade comprises a section of reduced thickness extending from the top portion.

14. The system of claim 13, wherein a thickness of the section of reduced thickness is smaller than a diameter of the component.

15. The system of claim 8, wherein the singulating blade comprises a flexed section, the flexed section not in contact with the singulating wall.

16. The system of claim 15, wherein the flexed section causes a bias in a non-flexed section of the singulating blade so as to maintain contact between the non-flexed section of the singulating blade and the singulating wall.

17. A system for singulating a component, comprising:
a hopper configured to contain at least one component, the hopper comprising:
a back wall;
a hopper wall;
a singulating wall, the back wall connected to both the hopper wall and the singulating wall; and
a feed surface configured to direct the component toward the singulating wall;
a singulating blade configured to slide between the singulating wall and the hopper wall between a first position and a second position, the singulating wall defining a component pocket sized and configured to receive the component; and
an actuator in communication with the singulating blade, the actuator configured to move the singulating blade between the first position and the second position so as to selectively carry the component to the component pocket.

18. The system of claim 17, wherein the feed surface defines an angled surface and a flat surface, the angled surface extending from the hopper wall to the flat surface, the flat surface extending from the angled surface to the singulating blade.

19. The system of claim 17, wherein the feed surface defines a convex surface and a flat surface, the convex surface extending from the hopper wall to the flat surface, the flat surface extending from the convex surface to the singulating blade.

20. The system of claim 17, wherein the feed surface defines an angled surface, a vertical surface, and a flat surface, the angled surface extending from the hopper wall to the vertical surface, the vertical surface extending from the angled surface to the flat surface, and the flat surface extending from the vertical surface to the singulating wall.

21. The system of claim 17, wherein the component pocket comprises a beveled edge, the beveled edge configured to prevent the component from rolling out of the component pocket.

22. The system of claim 17, wherein the component pocket comprises an angled surface, the angled surface and the top plate defining a wedge, wherein the wedge is configured to prevent the component from rolling out of the component pocket.
